(19) United States
(12) Patent Application Publication
(10) Pub. No.: US 2016/0259316 A1
(43) Pub. Date: Sep. 8, 2016

(54) MANAGEMENT SYSTEM FOR WORK MACHINE, MANAGEMENT METHOD FOR WORK MACHINE, AND WORK MACHINE

(71) Applicant: KOMATSU LTD., Minato-ku, Tokyo (JP)

(72) Inventors: Yuhei Ohta, Yokohama-shi (JP); Shinya Komori, Fujisawa-shi (JP); Tsuyoshi Imamura, Yokohama-shi (JP); Hiromi Tokura, Hiratsuka-shi (JP)

(73) Assignee: KOMATSU LTD., Tokyo (JP)

(21) Appl. No.: 14/427,423

(22) PCT Filed: Sep. 30, 2014
(86) PCT No.: PCT/JP2014/076203

§ 371 Date: Mar. 11, 2015

(51) Int. Cl. G05B 19/402; H04L 29/08

(52) U.S. Cl. CPC G05B 19/402; H04L 67/12; G05B 2219/37619

(57) ABSTRACT

A management system for a work machine includes: a work machine that has a communication terminal device with a communication function, a power source supplying power to the communication terminal device, and a switch interposed between the power source and the communication terminal device; and a management device that is capable of communication with the communication terminal device and transmits to the communication terminal device a request instruction for execution of a process for enabling the communication, wherein the communication terminal device, upon receipt of the request instruction from the management device, continues to receive power supply from the power source until after a lapse of a predetermined period of time since the switch turns from the on position to the off position.

### FIELD

The present invention relates to a management system for a work machine, a management method for a work machine, and a work machine.

### BACKGROUND

In recent years, there has been known a technique by which a management device or a terminal device acquires and manages operational information on a work machine such as an excavator or a dump truck. Patent Literature 1 describes a technique relating to a communication device in a movable body such as a construction machine for allowing communications between the movable body and a terminal device.

### CITATION LIST

### Patent Literature

Patent Literature 1: Unexamined Japanese Patent No. 2002-322685

### SUMMARY

### Technical Problem

When work machine having been produced at a plant is shipped from there and arrives at a destination, the work machine executes a process for establishing communications with a management device.

An object of the present invention is to, after shipment of a work machine configured to exchange information with a management device or the like via telecommunications, establish communications between the work machine and the management device or the like with higher probability.

### Solution to Problem

According to the present invention, a management system for a work machine, comprises: a work machine that has a communication terminal device with a communication function, a power source supplying power to the communication terminal device, and a switch interposed between the power source and the communication terminal device; and a management device that is capable of communication with the communication terminal device and transmits to the communication terminal device a request instruction for execution of a process for enabling the communication, wherein when the communication terminal device receives the request instruction from the management device, the communication terminal device continues to receive power supply from the power source until after a lapse of a predetermined period of time since the switch turns from an on position to an off position.

In the present invention, it is preferable that the communication terminal device executes the process for enabling communication with the management device before a lapse of the predetermined period of time.

In the present invention, it is preferable that the request instruction contains location information on a region relating to transport destination of the work machine.

In the present invention, it is preferable that after the communication terminal device executes the process for enabling communication with the management device, when the communication with the management device becomes enabled, the communication terminal device stops operations other than the communication with the management device.

In the present invention, it is preferable that after the communication terminal device executes the process for enabling communication with the management device, when the communication with the management device becomes enabled, the communication terminal device stops operations, and while the switch is in the off position, the communication terminal device is activated for a predetermined second period of time each after a lapse of a predetermined first period of time to communicate with the management device.

According to the present invention, a management system for a work machine, comprises: a work machine that has a communication terminal device with a communication function, a power source supplying power to the communication terminal device, a switch interposed between the power source and the communication terminal device, and a location detection device acquiring location information; and a management device that is capable of communication with the communication terminal device and transmits to the communication terminal device a request instruction containing location information on a region relating to transport destination of the work machine, the request instruction being for execution of a process for enabling the communication, wherein when the communication terminal device receives the request instruction from the management device, the communication terminal device acquires current location information on the work machine from the location detection device, when the communication terminal device determines that the work machine is located in a predetermined area of the transport destination from the current location information and the location information contained in the request instruction, the communication terminal device continues to receive power supply from the power source until after a lapse of a predetermined period of time since the switch turns from an on position to an off position, and executes the process for enabling communication with the management device before a lapse of the predetermined period of time.

According to the present invention, a management method for a work machine by which to manage the work machine that has a communication terminal device with a communication function, a power source supplying power to the communication terminal device, and a switch interposed between the power source and the communication terminal device, by a use of a management system for the work machine including the work machine and a management device that is capable of communication with the communication terminal device and transmits to the communication terminal device a request instruction for execution of a process for enabling the communication, the management method comprises: receiving the request instruction from the management device; and when the request instruction is received, continuing to receive power supply from the power source before a lapse of a predetermined period of time since the switch turns from an on position to an off position.

According to the present invention, a work machine, comprises: a communication terminal device with a communication function; a power source supplying power to the communication terminal device; and a switch interposed between the power source and the communication terminal device, wherein when the communication terminal device receives a request instruction for execution of a process for enabling communication with the management device, the communication terminal device continues to receive power supply from the power source until after a lapse of a predetermined period of time since the switch turns from an on position to an off position.

In the present invention, it is preferable that the communication terminal device executes the process for enabling communication with the management device before a lapse of the predetermined period of time.

In the present invention, it is preferable that the request instruction contains location information on a region relating to transport destination of the work machine.

In the present invention, it is preferable that after the communication terminal device executes the process for enabling communication with the management device, when the communication with the management device becomes enabled, the communication terminal device stops operations other than the communication with the management device.

In the present invention, it is preferable that after the communication terminal device executes the process for enabling communication with the management device, when the communication with the management device becomes enabled, the communication terminal device stops operations, and while the switch is in the off position, the communication terminal device is activated for a predetermined second period of time each after a lapse of a predetermined first period of time to communicate with the management device.

According to the present invention, a work machine, comprises: a communication terminal device with a communication function; a power source supplying power to the communication terminal device; a switch interposed between the power source and the communication terminal device; and a location detection device acquiring location information, wherein when the communication terminal device receives a request instruction containing location information on transport destination of the work machine, the request instruction being for execution of a process for enabling communication with the management device from the management device, the communication terminal device acquires current location information on the work machine from the location detection device, and when the communication terminal device determines that the work machine is located in a predetermined area of the transport destination from the current location information and the location information contained in the request instruction, the communication terminal device continues to receive power supply from the power source until after a lapse of a predetermined period of time since the switch turns from an on position to an off position, and executes the process for enabling communication with the management device before a lapse of the predetermined period of time.

### Advantageous Effects of Invention

According to the present invention, it is possible to, after shipment of a work machine configured to exchange information with a management device or the like via telecommunications, establish communications between the work machine and the management device or the like with higher probability.

### BRIEF DESCRIPTION OF DRAWINGS

FIG. 1 is a diagram illustrating worksites to which a management system 100 for a work machine according to an embodiment is applied.

FIG. 2 is a diagram illustrating one example of the management system 100 for the work machine according to the embodiment.

FIG. 3 is a flowchart of a processing procedure in a management method for a work machine according to the embodiment.

FIG. 4 is a flowchart of a processing procedure in the management method for the work machine according to the embodiment.

FIG. 5 is a conceptual diagram illustrating one example of a request instruction CMD.

FIG. 6 is a diagram illustrating determination on a region where work machine 1 is located.

FIG. 7 is a timing chart of a transportation mode.

FIG. 8 is a timing chart of the management method for the work machine according to the embodiment.

### DESCRIPTION OF EMBODIMENTS

Embodiments for carrying out the present invention will be described in detail with reference to the accompanying drawings.

<Overview of Management System 100>

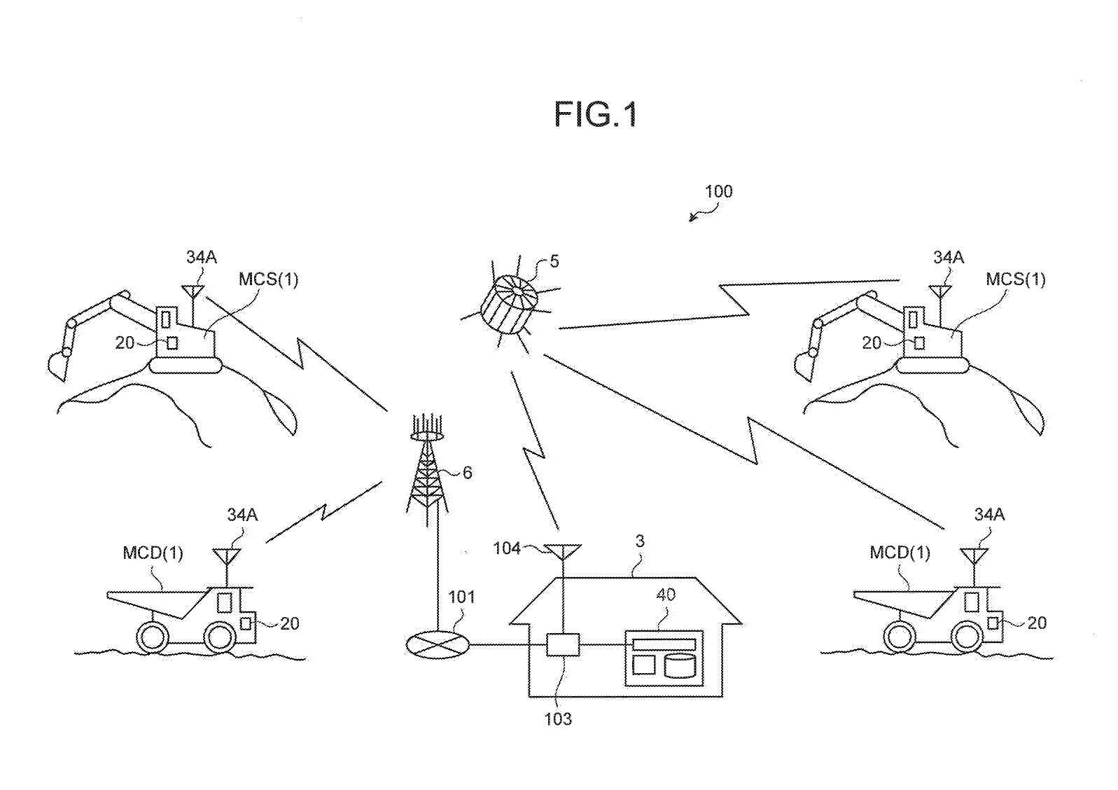

FIG. 1 is a diagram illustrating worksites to which a management system 100 for a work machine according to an embodiment is applied. The management system for the work machine (hereinafter, referred to as appropriate as management system) 100 causes a management device 40 to collect operational information on work machine 1 via a communication line 101 or a communications satellite 5, causes electronic devices included in the work machine 1 or devices controlled by the electronic devices (hereinafter, referred to as appropriate as electronic devices and others) to execute processes, and changes settings on the electronic devices and others.

In the example of FIG. 1, the management system 100 causes communication terminal devices 20 in dump trucks MCD and excavators MCS as the work machine 1 to establish communications with the management device 40, collects operational information on the work machine 1, and causes the electronic devices and the others in the work machine 1 to execute some processes. In the embodiment, the work machine is not limited to dump trucks MCD and excavators MCS. For example, the management system 100 may manage wheel loaders, bulldozers, forklifts, and the like. In the following description, the dump trucks MCD and the excavators MCS will be referred to as appropriate as the work machine 1.

In the management system 100, for example, the management device 40 and the communication terminal device included in the work machine 1 communicate with each other via a wireless communication system applied to communications by mobile objects such as cellular phones, a wireless LAN (local area network), or a satellite communication line using the communications satellite 5. The management device 40 is installed in a management facility 3, for example. The management facility 3 may be provided in a worksite in which the work machine 1 is operated, or may be provided in a location remote from the worksite in which the work machine 1 is operated, or may be provided in a place in the presence of a serviceperson performing preventive maintenance of the work machine 1 or a superintendent of the worksite, for example. The management device 40 may be installed in a fixed place or may be movable to an arbitrary place as in the case of a cellular phone including a function of wireless communications.

In the embodiment, the management device 40 communicates with the communications satellite 5 via a communication device 103 and an antenna 104 for satellite communications connected to the communication device 103. The management device 40 and the communication terminal device 20 included in the work machine 1 communicate with each other via satellite communication lines using the communications satellite 5 to exchange various kinds of information. The management device 40 may also be configured to exchange the various kinds of information with the communication terminal device 20 included in the work machine 1 via the communication device 103, the communication line 101 connected to the communication device 103, and a base station 6 connected to the communication line 101.

The communication terminal device 20 included in the work machine 1 receives an instruction or request for processing from the management device 40, or transmits to the management device 40 operational information on the work machine 1 and various kinds of information or signals in response to the foregoing instruction or request for processing. The communication terminal device 20 transmits information from a communication antenna 34A to the outside. The management device 40 receives (acquires) various kinds of information transmitted from the communication terminal device 20 in the work machine 1 via the base station 6, the communication line 101, and the communication device 103. The processes instructed or requested by the management device 40 include a process for causing the communication terminal device 20 in the work machine 1 to establish communications with the management device 40.

The management device 40 requests the electronic devices and others included in the work machine 1 to perform processes, and changes functional settings on the electronic devices and others. In this case, the management device 40 transmits a command or information to be delivered to the work machine 1, to the communications satellite 5 or the communication line 101 via the communication device 103. The command or information is transmitted to the work machine 1 by radio waves from the communications satellite 5 or the base station 6. The radio waves containing the command or information as described above transmitted from the base station 6 are received by the communication antenna 34A of the work machine 1.

The communication terminal device 20 in the work machine 1 demodulates and converts the radio waves received at the communication antenna 34A into original information capable of being decrypted by a processing unit 20C of the communication terminal device 20 described later. In such a manner as described above, the work machine 1, more specifically, the communication terminal device 20 and the management device 40 can exchange information with each other via wireless communications. Next, the work machine 1, the management device 40, and the management system 100 will be described in more detail.

<Details of the Management System 100>

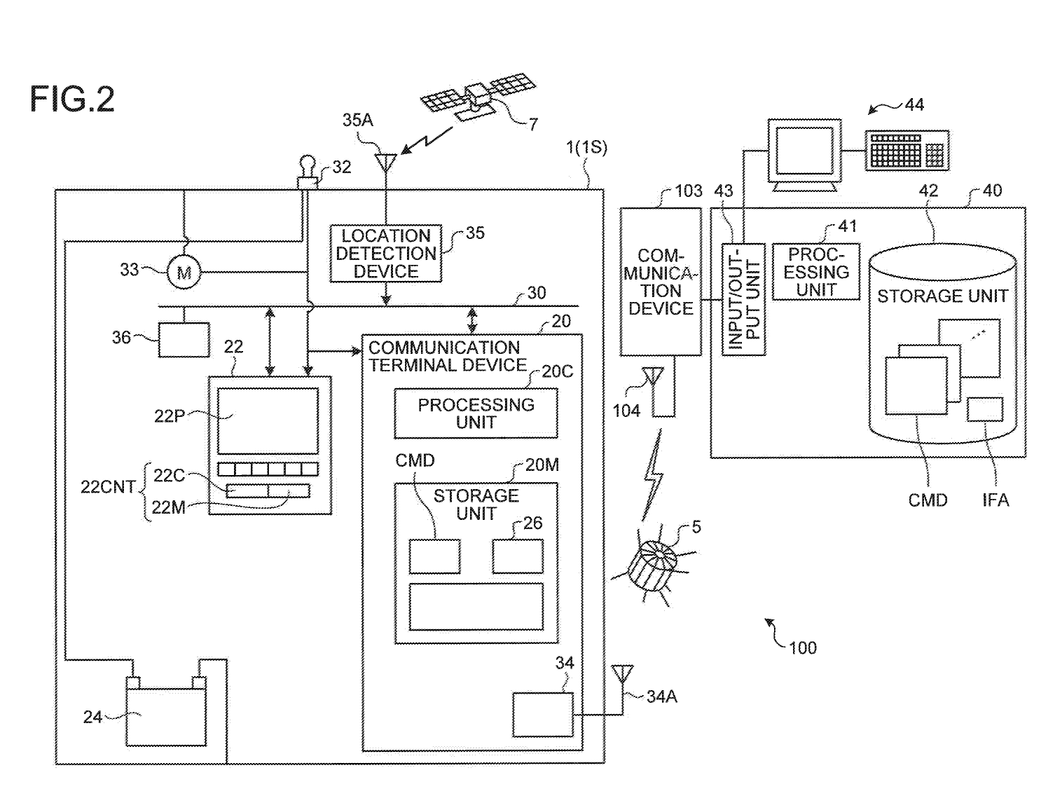

FIG. 2 is a diagram illustrating one example of the management system 100 for the work machine according to the embodiment. The management system for the work machine 100 includes the management device 40 in a management facility and a vehicle-mounted system 1S in the work machine 1. In the following description, the management device 40 and the vehicle-mounted system 1S exchange information via the communication device 103 and the communications satellite 5 as an example. Alternatively, the management device 40 and the vehicle-mounted system 1S exchange information via the base station 6 and the communication line 101 illustrated in FIG. 1.

In the management system 100, the communication terminal device 20 in the vehicle-mounted system 1S receives a command or information transmitted from the management device 40 via the communications satellite 5. The communication terminal device 20 executes the received command to perform a process for establishing communications with the management device 40, for example. The communication terminal device 20 also collects operational information on the work machine 1 and transmits the same to the management device 40 with a predetermined timing. Besides, the communication terminal device 20 transmits the received command or information to the electronic devices and others in the work machine 1 via a signal line 30 in the vehicle-mounted system 1S for execution of the command described above.

In the embodiment, for convenience of description, one piece of the work machine 1, one vehicle-mounted system 1S, and one management device 40 are connected together via the communication line 101. However, there is no limitation on the numbers of the work machine 1 and the management device 40. Next, the vehicle-mounted system 1S will be described.

(Vehicle-Mounted System 1S)

The vehicle-mounted system 1S has the communication terminal device 20, a monitor 22, and a location detection device 35. These electronic devices are electrically connected to the signal line 30 included in the work machine 1. The electronic devices connected to the signal line 30 can communicate with one another. Hereinafter, the in-vehicle signal line 30 included in the work machine 1 will be referred to as appropriate as in-vehicle signal line 30. The in-vehicle signal line 30 is a CAN (controller area network), for example, but is not limited to the CAN. The electronic devices included in the work machine 1 and connected to the in-vehicle signal line 30 are not limited to the ones described above.

A key switch 32 is provided near the driver's seat in the work machine 1. The key switch 32 is interposed between a capacitor 24 and the electronic devices such as the communication terminal device 20 and the monitor 22 to supply power to these components. The power from the storage battery 24 as a power source in the work machine 1 is supplied to the electronic devices via the key switch 32. When the key switch 32 is turned on, the power from the capacitor 24 is supplied to the electronic devices. When the key switch 32 is turned off, the power supplied from the capacitor 24 to the electronic devices is shut off.

When the operator of the work machine 1 operates the key switch 32, the power from the storage battery 24 is supplied to the electronic devices in the work machine 1 and a starter motor 33 of the engine.

The communication terminal device 20 has a function of communications, for example, a function of performing wireless communications with the management device 40 for exchange of information. The communication terminal device 20 has the processing unit 20C, a storage unit 20M, and a communication unit 34. The processing unit 20C is a CPU (central processing unit), for example. The storage unit 20M is a RAM (random access memory), a ROM (read only memory), a flash memory, or a combination thereof. The storage unit 20M stores computer programs describing commands for processes to be executed by the communication terminal device 20 and information necessary for the processes, and others. The storage unit 20M may temporarily store information transmitted from the management device 40. The information temporarily stored in the storage unit 20M includes a request instruction CMD transmitted from the management device 40. The request instruction CMD is used for execution of a process for enabling the communication terminal device 20 in the work machine 1 to communicate with the management device 40.

The communication unit 34 includes a modem and the communication antenna 34A to perform wireless communications, specifically, satellite communications with the communications satellite 5. The communication unit 34 can exchange information with the management device 40 via the communications satellite 5 and the communication device 103.

The communication unit 34 is activated even when the key switch 32 is in the off position. Specifically, the communication terminal device 20 can perform communications even when the key switch 32 is in the off position as described below. Upon receipt of an instruction from the management device 40, the communication unit 34 can supply power from the capacitor 24 to the processing unit 20C to activate the processing unit 20C. In this case, the management device 40 may be configured to re-transmit the foregoing instruction in a predetermined cycle to the communication unit 34 until the communication unit 34 receives the instruction. While the key switch 32 is in the off position, the communication unit 34 may repeat supply and shutoff of power from the storage battery 24 to the communication terminal device 20 at predetermined time intervals, and the communication unit 34 may communicate with the management device 40 when the power is supplied to the communication terminal device 20. When the power is supplied to the communication terminal device 20 while the key switch 32 is in the off position, the communication terminal device 20 can transmit the operational information to the management device 40, for example. In the embodiment, a mode in which the communication unit 34 operates with the key switch 32 in the off position as described above will be referred to as ready mode. Another mode in which the communication unit 34 operates with the key switch 32 in the off position will be referred to as transportation mode, which will be described later in detail.

The monitor 22 is a display device that displays on a screen 22P various kinds of information on the work machine 1 and serves as an input device for inputting ID codes or the like. The monitor 22 may be a liquid crystal display with an input device, for example. The monitor 22 may be a touch panel, for example. The input device may be separated from the display device of the monitor 22. The monitor 22 includes a control device 22CNT for realizing various functions of the monitor 22. The control device 22CNT includes a processing unit 22C and a storage unit 22M. The processing unit 22C is a CPU, for example. The storage unit 22M is a RAM, a ROM, a flash memory, or a combination thereof. The storage unit 22M stores computer programs describing commands for processes to be executed by the processing unit 22C and information necessary for the processes to be executed by the processing unit 22C. In the embodiment, the monitor 22 communicates with the communication terminal device 20 via the in-vehicle signal line 30.

The location detection device 35 detects the current location of the work machine 1 using RTK-GNSS (real time kinematic-global navigation satellite systems). The location detection device 35 is electrically connected to an antenna 35A. The antenna 35A is a GNSS antenna. A signal according to a GNSS radio wave is received by the antenna 35A from a RTK-GNSS satellite 7 and is input into the location detection device 35. The location detection device 35 detects the installed position of the antenna 35A (the current location of the work machine 1). The location detection device 35 includes a three-dimensional location sensor, for example. The location detection device 35 may be incorporated into the communication terminal device 20.

The communication terminal device 20 acquires the location information on the work machine 1 from the location detection device 35 during operation of the work machine 1, and stores the same as one piece of an operational information 26 on the work machine 1 in the storage unit 20M. The communication terminal device 20 also acquires, as the operational information 26 on the work machine 1, information on the status of the work machine such as engine speed, cooling water temperature, exhaust gas temperature, and pressure and temperature of a working oil discharged from a hydraulic pump, from various sensors 36 connected to the in-vehicle signal line 30, and stores the same in the storage unit 20M. The communication terminal device 20 transmits the acquired operational information 26 on a regular basis, once a day, for example, to the management device 40. In addition, according to a request from the management device 40, the communication terminal device 20 transmits the requested information or executes the requested command.

(Management Device 40)

The management device 40 acquires the operational information on the work machine 1 from the communication terminal device 20 in the work machine 1 and manages the operating status of the work machine 1. In the embodiment, the management device 40 manages the one or plurality of the work machine 1, but there is no limitation on the number of the work machine 1 managed by the one management device 40.

The management device 40 includes a processing unit 41, a storage unit 42, and an input/output unit 43. The processing unit 41 is a CPU, for example. The storage unit 42 is a RAM, a ROM, a flash memory, a hard disc drive, or a combination thereof. The storage unit 42 stores a request instruction CMD. The processing unit 41 executes a process for transmitting the request instruction CMD to the communication terminal device 20 in the work machine 1 via the communication device 103. The work machine 1 is transported from a plant or the like for shipment, export, or the like. At that time, a schedule until arrival at the destination site (destination) is drawn up. In the embodiment, besides the request instruction CMD, the storage unit 42 stores information on the schedule according to which the work machine 1 having been transported for shipment or export by sea or by road will arrive at the destination (hereinafter, referred to as appropriate as scheduled arrival information) IFA. The input/output unit 43 performs input/output of information between the communication device 103 connected to the management device 40 and the processing unit 41 and input/output of information between an input/output device 44 and the processing unit 41.

The management device 40 has the input/output unit 43 electrically connected to the communication device 103. The communication device 103 is electrically connected to the antenna 104 performing wireless communications with the communications satellite 5. The management device 40, more specifically, the processing unit 41 in the management device 40 transmits various kinds of information including various commands to the communication terminal device 20 in the work machine 1, via the communication device 103, the antenna 104, and the communications satellite 5. The processing unit 41 in the management device 40 also receives various kinds of information transmitted from the communication terminal device 20 in the work machine, via the communications satellite 5 and the communication device 103. The processing unit 41 also transmits commands or information or the like to the work machine 1 via the communication device 103 and the communication line 101.

<Shipment of the Work Machine 1>

The work machine 1 manufactured at a plant is shipped, loaded onto a boat, train, trailer, or the like, and transported to the destination. Upon arrival of the work machine 1 including the communication terminal device 20 at the destination, the communication terminal device 20 executes a process for enabling communications with the management device 40 to establish communications with the management device 40. This process will be referred to as opening inspection process.

In the embodiment, since the opening inspection process is not completed during the shipment, the communication terminal device 20 can receive information from the management device 40 but cannot transmit information to the management device 40. Upon completion of the opening inspection process, the communication terminal device 20 can transmit information to the management device 40. Specifically, by executing and completing the opening inspection process, the communication terminal device 20 can perform interactive communications with the management device 40.

The opening inspection process is intended to allow the work machine 1 having arrived at the destination to perform interactive communications with the management device 40. The opening inspection process is performed to inspect whether the location detection device 35 can normally function to acquire location information on the work machine 1, and inspect whether the communication terminal device 20 in the work machine 1 can normally exchange information with the management device 40 via the communications satellite 5 or the base station 6, for example. The contents of the opening inspection process are not limited to them but may include other processes or additional processes as far as the processes are necessary for the management device 40 to acquire the operational information on the work machine 1.

In the case where the work machine 1 is shipped abroad, the work machine 1 is generally loaded on a boat and transported over sea (sea transportation). Also in the case where the work machine 1 is shipped domestically, sea transportation may be selected taking into account transport distance to the destination, costs for transport means, convenience, or the like. Otherwise, the work machine 1 may be transported to the destination by rail or trailer on the road for many days. In the embodiment, the case of sea transportation will be described below. For example, when the work machine 1 is to be shipped to the destination by sea transportation or the like, it may take several to several tens of days before the work machine 1 arrives at the port of destination, depending on the region and district. During the transportation, if the communication terminal device 20 enters the ready mode to receive power supply at predetermined time intervals and communicate with the management device 40 on a regular basis, excess communication costs may occur or the communication terminal device 20 may waste electric power in the storage battery 24. Accordingly, during transportation of the work machine 1, the communication terminal device 20 is set in the state so as not to enter the ready mode. This state will be referred to as transportation mode in the embodiment. For example, the communication terminal device 20 can be set in the transportation mode by reading a menu screen from the monitor 22 and performing an operation on the same.

When the work machine 1 is shipped by boat, the communication terminal device 20 executes the opening inspection process at a port or a storage yard of the transport destination. When executing the opening inspection process, the communication terminal device 20 needs to be activated with power supply from the storage battery 24. Accordingly, there is a first method for executing and completing the opening inspection process by which to keep the key switch 32 in the on position in the transportation mode until completion of the opening inspection process. In addition, there is a second method for executing and completing the opening inspection process by which to clear the transportation mode and shift the communication terminal device 20 to the ready mode.

When the first method is used, the key switch 32 continues to be in the on position, that is, the engine of the work machine 1 continues to operate, which may lead to increase in the operating time of the work machine 1 and the fuel consumption of the engine. In addition, according to the first method, the operator needs to monitor the opening inspection process until its end, which is a burdensome task. When the second method is used, the service person needs to read a menu screen from the monitor 22 and perform an operation thereon to bring the communication terminal device 20 into the ready mode, which is also a burdensome task. Under the second method, the service person needs to know the contents of the operation, and it is thus difficult in many cases for the service person to execute and complete the opening inspection process by means of the second method at a port or a storage yard of the transport destination.

As described above, whether the first method or the second method is used, it is difficult to complete the opening inspection process of the work machine 1 at a port or a storage yard of the transport destination. As a result, while the work machine 1 is delivered from the port or the storage yard of the transport destination to the next transport destination, an agency, for example, the communication terminal device 20 and the management device cannot communicate with each other, and thus the management device 40 cannot collect the operational information on the work machine 1. Accordingly, the management system 100 executes a management method for the work machine according to the embodiment to allow the communication terminal device 20 to complete the opening inspection operation at the transport destination of the work machine 1.

<Management Method for the Work Machine According to the Embodiment>

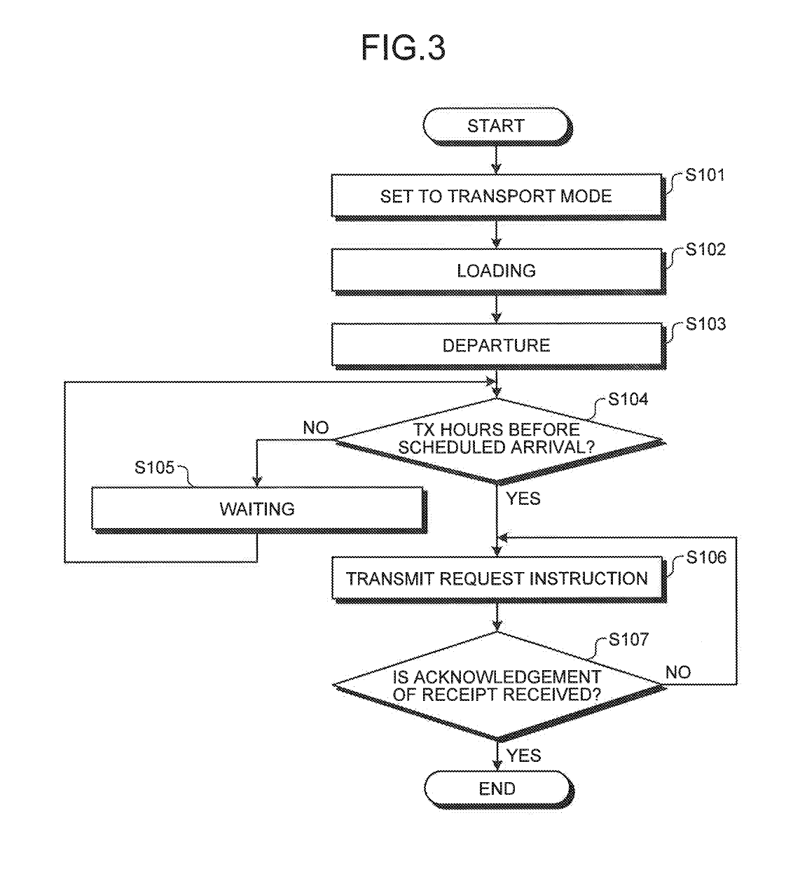

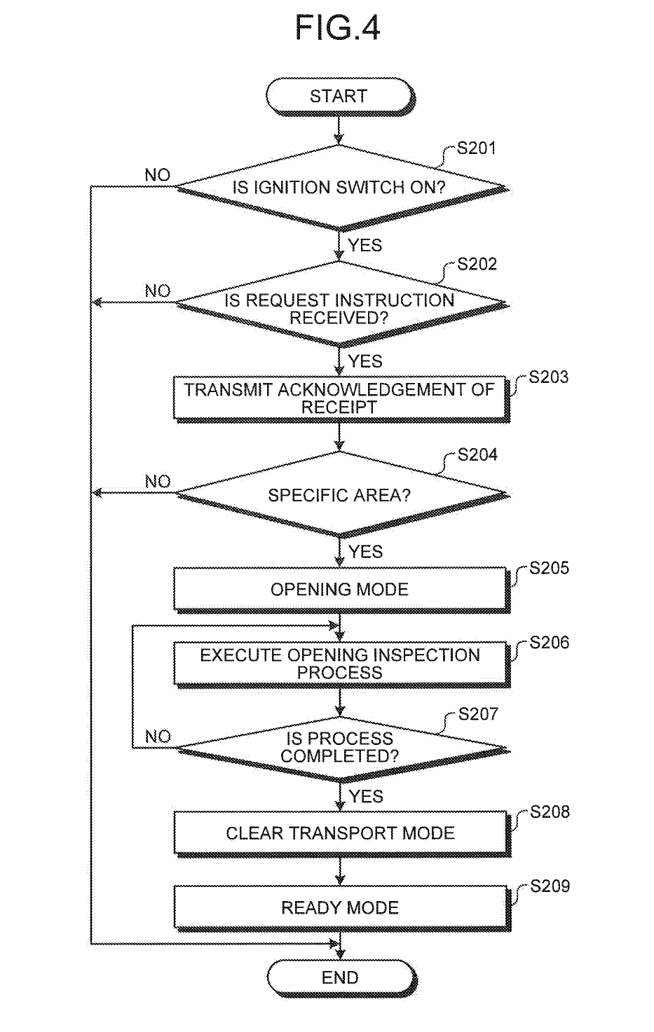

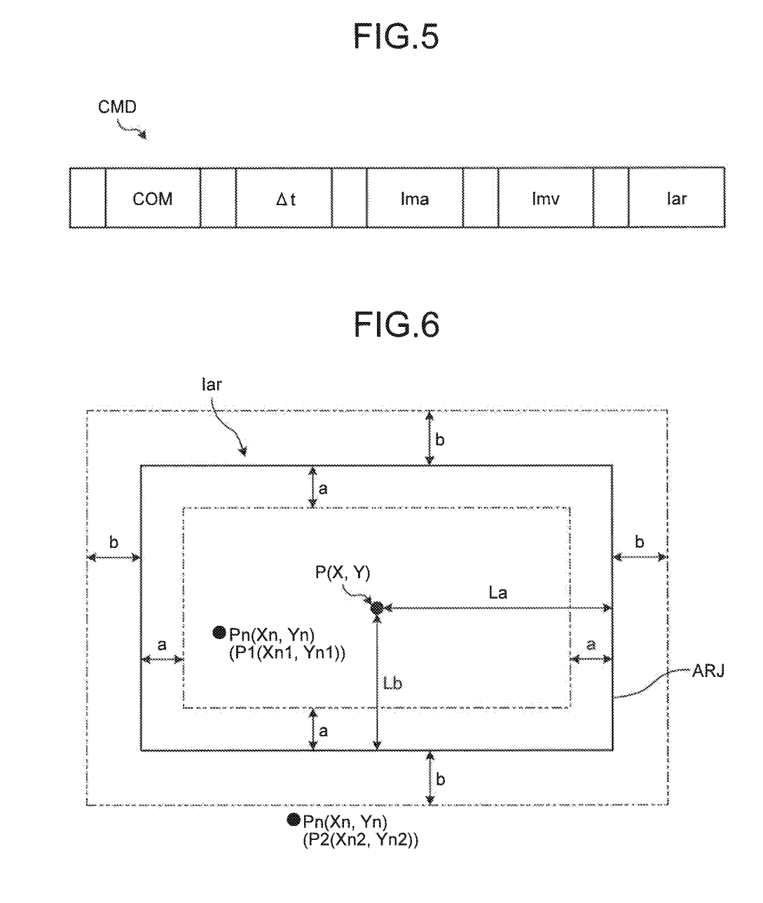

FIGS. 3 and 4 are flowcharts of processing procedures in a management method for the work machine according to the embodiment. FIG. 5 is a conceptual diagram illustrating one example of a request instruction CMD. FIG. 6 is a diagram illustrating determination on a region where the work machine 1 is located. In the following description, the work machine 1 manufactured at a plant is shipped and transported by boat on the sea as an example. However, the application of the management method for the work machine according to the embodiment is not limited to shipment for export. In addition, the management method for the work machine according to the embodiment is not limited to sea transportation of the work machine 1 but may be applied to overland transportation by rail or trailer.

First, referring to FIG. 3, the management method for the work machine according to the embodiment executed by the management device 40 will be described. When the work machine 1 is manufactured at a plant, the mode of the communication terminal device 20 illustrated in FIG. 2 is set to the transportation mode before shipment at step S101. At step S102, the work machine 1 with the communication terminal device 20 in the transportation mode is loaded on a boat at a port, for example. At step S103, the boat loaded with the work machine 1 leaves for a port as a transport destination. The boat runs toward the destination. Since the work machine 1 on the boat has the communication terminal device 20 in the transportation mode until the boat loaded arrives at the destination, the ready mode is not enabled even if the key switch 32 illustrated in FIG. 2 is in the off state, whereby no wasteful communications occur between the communication terminal device 20 and the management device 40.

Next, at step S104, the processing unit 41 in the management device 40 illustrated in FIG. 2 determines whether it has been TX hours before the scheduled time of arrival of the boat loaded with 1 at the destination. As described above, the management device 40 stores the scheduled arrival information IFA in the storage unit 42. The scheduled arrival information IFA contains at least information on when the work machine 1 as a target of transportation will arrive at the destination, that is, information on the scheduled arrival time. The processing unit 41 reads the scheduled arrival information IFA from the storage unit 42, and determines whether it has been TX hours before the scheduled time of arrival at the destination, from the current time and the scheduled arrival time. When it has not yet been TX hours before the scheduled arrival time (No at step S104), the management device 40 waits for execution of step S106 until it has been TX hours before the scheduled arrival time at step S105. When it has been TX hours before the scheduled time of arrival at the destination (Yes at step S104), the management device 40 executes step S106.

At step S106, the management device 40 transmits the request instruction CMD from the storage unit 42 to the communication terminal device 20 in the work machine 1 when it has been TX hours before the scheduled arrival time. There is no limitation on TX hours before (timing) for use at step S104, but TX hours is preferably set such that the request instruction CMD can be reliably transmitted even if satellite communications are made between the management device 40 and the communication terminal device 20 in the work machine 1.

When the request instruction CMD from the storage unit 42 is transmitted to the work machine 1, the management device 40 determines at step S107 whether an acknowledgement of receipt of the request instruction CMD has been received from the communication terminal device 20 in the work machine 1. When not determining that an acknowledgement of receipt has been received (No at step S107), the management device 40 repeats steps S106 and S107 until an acknowledgement of receipt has been received. When determining that an acknowledgement of receipt has been received (No at step S107), the management device 40 terminates the process in the management method for the work machine according to the embodiment.

Next, referring to FIG. 4, a process executed by the communication terminal device 20 in the work machine 1 in the management method for the work machine according to the embodiment will be described. When the boat loaded with the work machine 1 arrives at the port as the destination, unloading is started. The key switch 32 illustrated in FIG. 2 is turned on after the work machine 1 is on the boat or discharged into a port facility. When the key switch 32 is not turned on at step S201 (No at step S201), the communication terminal device 20 is not activated. In this case, the communication terminal device terminates the process.

When the key switch 32 is turned on at step S201 (Yes at step S201), the communication terminal device 20, more specifically, the processing unit 20C determines at step S202 whether the communication unit 34 has received the request instruction CMD from the management device 40. When the processing unit 20C does not determine that the communication unit 34 has received the request instruction CMD from the management device 40 (No at step S202), the communication terminal device 20 terminates the process. When the processing unit 20C determines that the communication unit 34 has received the request instruction CMD from the management device 40 (Yes at step S202), the communication terminal device 20 moves to step S203 to transmit an acknowledgement of receipt to the management device 40.

As illustrated in FIG. 5, the request instruction CMD contains a command COM, a time difference Δt, a geodetic system information Ima, movement information Imv, and destination information Iar. The command COM is a command for causing the communication terminal device 20 illustrated in FIG. 2 to execute the opening inspection process for the management device 40. The time difference Δt is a time difference between the region in which the management device 40 is installed and the destination. The geodetic system information Ima is information on an RTK-GNSS geodetic system to be used by the location detection device 35 illustrated in FIG. 2, and, in this example, is information on a RTK-GNSS geodetic system at the destination, that is, the country to which the work machine 1 is transported. The movement information Imv is information on the distance traveled by the work machine 1 from the departure place to the destination and on means of transportation. The destination information Iar is location information on the region in which the shipped work machine 1 is unloaded, that is, the region related to the transport destination of the work machine 1. More specifically, the destination information Iar is location information on a predetermined region or place of the destination (transport destination) of the work machine 1. The destination information Iar is information on a district including a free-trade zone in the region where the work machine 1 is discharged, for example.

The destination information Iar includes a center position P(X, Y) of a specific area (hereinafter, referred to as appropriate as specific area) ARJ at the destination, a dimension La along X direction, and a dimension Lb along Y direction, as illustrated in FIG. 6. The X denotes longitude and the Y denotes latitude. The specific area ARJ has a distance of 2×La along the X direction and a distance of 2×Lb along the Y direction around the center position P(X, Y).

When determining at step S203 that an acknowledgement of receipt has been transmitted to the management device 40, the communication terminal device 20 moves to step S204 to determine whether the work machine 1 is located in the specific area ARJ of the destination. On that determination, the processing unit 20C of the communication terminal device 20 first acquires the current location Pn(Xn, Yn) as current location information on the work machine 1 from the location detection device 35. Next, the processing unit 20C determines a distance Lnx and a distance Lyn between the center position P(X, Y) and the current location Pn(Xn, Yn). Then, the processing unit 20C determines whether the work machine 1 is located in the specific area ARJ of the destination from the destination information Iar the center position P(X, Y), the dimension La along the X direction, the dimension Lb along the Y direction, and the current location Pn(Xn, Yn), in such a manner as described below. In the embodiment, the processing unit 20C uses a first determination threshold a and a second determination threshold b to determine whether the work machine 1 is located in the specific area ARJ. These thresholds are constants stored in the storage unit 20M. The values of the first determination threshold a and the second determination threshold b can be changed from the monitor 22 illustrated in FIG. 2, for example. The first determination threshold a and the second determination threshold b may be identical or different in value. There is no limitation on magnitudes of the first determination threshold a and the second determination threshold b, but the values of the first determination threshold a and the second determination threshold b may be larger than the entire length of the work machine 1 to be determined.

When a first condition is satisfied, the processing unit 20C determines that the work machine 1 is located in the specific area ARJ. When a second condition is satisfied, the processing unit 20C does not determine that the work machine 1 is located in the specific area ARJ. First condition: The distance Lnx along the X direction takes a value equal to or less than a value obtained by subtracting the first determination threshold a from the dimension La along the X direction in the specific area ARJ, and the distance Lyn along the Y direction takes a value equal to or less than a value obtained by subtracting the first determination threshold a from the dimension Lb along the Y direction in the specific area ARJ. That is, Lnx≦La−a and Lny≦Lb−a.

Second condition: The distance Lnx along the X direction takes a value larger than a value obtained by subtracting the second determination threshold b from the dimension La along the X direction in the specific area ARJ, or the distance Lyn along the Y direction takes a value larger than a value obtained by subtracting the second determination threshold b from the dimension Lb along the Y direction in the specific region ARJ. That is, Lnx>La−b or Lny>Lb−b. The second condition may be Lnx>La−b and Lny>Lb−b.

In the example illustrated in FIG. 6, when the current location is at P1(Xn1, Yn1), the first condition is satisfied and thus the processing unit 20C determines that the work machine 1 is located in the specific area ARJ. When the current location is at P2(Xn2, Yn2), the second condition is satisfied and thus the processing unit 20C does not determine that the work machine 1 is located in the specific area ARJ.

When the work machine is not located in the specific area ARJ (No at step S204), the communication terminal device 20 terminates the process. When the work machine is located in the specific area ARJ (Yes at step S204), the communication terminal device 20 moves to step S205. Next, the communication terminal device 20 shifts the operation mode to an opening mode while keeping the transportation mode. In the opening mode, after the key switch 32 turns from the on position to the off position, the communication terminal device 20 receives power supply from the storage battery 24 until a predetermined period of time has elapsed.

Next, the communication terminal device 20 executes the opening inspection process at step 3206 before a predetermined period of time has elapsed in the opening mode to establish communications with the management device 40. Upon completion of the opening inspection process, communications are enabled between the communication terminal device 20 and the management device 40. At step S207, when determining that the opening inspection process is not completed (No at step S207), the communication terminal device 20 returns to step S206 to continue the opening inspection process. In the embodiment, the communication terminal device 20 shifts to the opening mode at step S205, and thus even if the key switch 32 is turned off during execution of the opening inspection process by the communication terminal device 20, the communication terminal device 20 continues to receive power supply from the storage battery 24. Accordingly, the communication terminal device 20 can continue the opening inspection process until its completion, thereby establishing communications with the management device 40 with higher probability.

There is no specific limitation on the predetermined period of time in the opening mode, but the predetermined period of time is preferably set such that, even if satellite communications are performed between the communication terminal device 20 and the management device 40, the opening inspection process can be completed with higher probability. When determining that the opening inspection process is completed (Yes at step S207), the communication terminal device 20 moves to step S208 to automatically clear the transportation mode. Then, the communication terminal device 20 moves to step S209 to automatically shift the operation mode to the ready mode, and then the communication terminal device 20 terminates the process.

In the ready mode, when the key switch 32 is in the off position, the communication terminal device 20 has the communication function enabled and stops operations other than communications, and when the communication unit 34 receives an instruction from the management device 40, the communication terminal device 20 is allowed to perform operations other than communication. Alternatively, in the ready mode, when the key switch 32 is in the off position, the communication terminal device 20 may repeat activation and stoppage at predetermined time intervals.

<Operation Example>

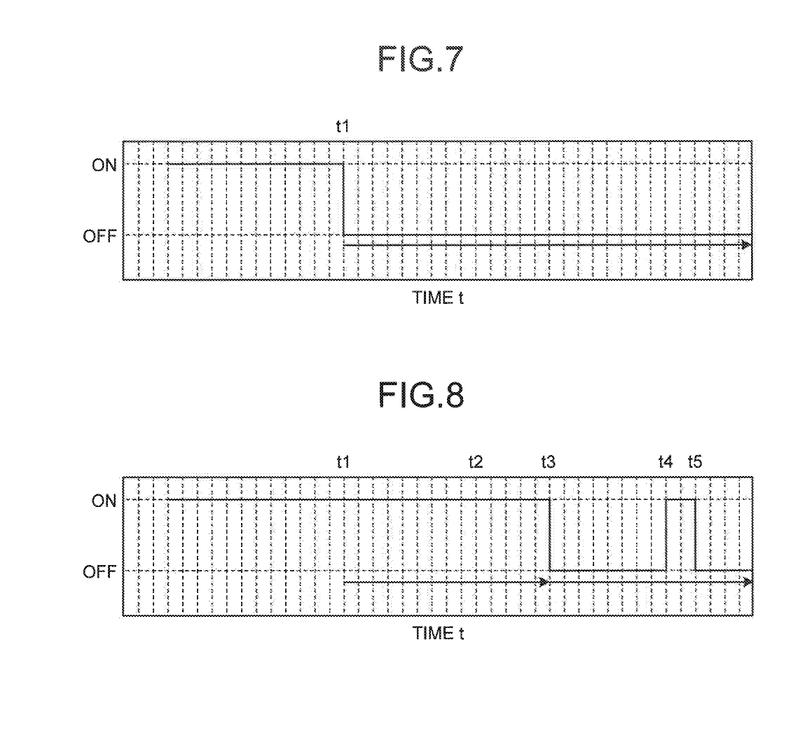

FIG. 7 is a timing chart of the transportation mode. FIG. 8 is a timing chart of the management method for the work machine according to the embodiment. FIGS. 7 and 8 each illustrate relations between the operational state of the communication terminal device 20 and time t. The state in which the communication terminal device 20 is operating with power supply from the capacitor 24 will be referred to as on state, and the state in which power supply from the storage battery 24 to the communication terminal device 20 is stopped and the communication terminal device 20 is not operating will be referred to as off state.

In the case where the communication terminal device 20 executes the opening inspection process with the key switch 32 in the on position without clearing the transportation mode at a storage yard or the like of the destination, when the key switch 32 is turned off at time t1 as illustrated in FIG. 7, the communication terminal device 20 also turns off and stops operation. As a result, the opening inspection process is interrupted and no communication between the communication terminal device 20 and the management device 40 can be established.

In the management method for the work machine according to the embodiment, as illustrated in FIG. 8, the communication terminal device 20 has shifted to the opening mode when the key switch 32 has turned on. In the opening mode, even after the key switch 32 is turned off at time t1, the communication terminal device 20 does not turn off until a predetermined period of time has elapsed. In this example, the communication terminal device 20 continues to be in the on state from time t=t1 when the key switch 32 is turned off to time t=t3. The predetermined period of time is between the time t=t1 and the time t=t3. That is, the communication terminal device 20 continues to be in the on state for the period of time (t3−t1). The period of time necessary for the opening inspection process is (t2−t1), which is shorter than the period of time (t3−t1). Accordingly, the communication terminal device 20 can complete the opening inspection process with higher probability and establish communication with the management device 40.

Upon end of the opening mode, that is, when the key switch 32 is turned from the on position to the off position, after a predetermined period of time has elapsed (since the time t=t3), the communication terminal device shifts to the ready mode. In the ready mode, the communication unit 34 is repeatedly activated and stopped at a predetermined first time interval when the key switch 32 is in the off position. In this example, the communication unit 34 is turned on and activated at the time t=t4, and is turned off and stopped at the time t=t5. Since the communication unit 34 is turned on at the time t=t4, the communication unit 34 is repeatedly activated and stopped at predetermined intervals of a first period of time (t4−t3). The communication unit 34 is activated at the predetermined intervals of the first period of time (t4−t3) for a second period of time (t5−t4). The second period of time is pre-decided.

As described above, by executing the management method for the work machine according to the embodiment by the management system 100, the success rate of the opening inspection process can be improved. In this case, the success ratio of the opening inspection process can be more improved as compared to the case where the communication unit 34 is repeatedly activated and stopped at predetermined time intervals when the key switch 32 is in the off position. In addition, the opening inspection process is automatically completed by the communication terminal device 20 in the work machine 1 upon receipt of the request instruction CMD from the management device 40, which eliminates the need for the service person to perform operations. Accordingly, even if the work machine 1 is located at a port or a storage yard of the destination, the opening inspection process can be completed in an easy manner. In addition, the communication terminal device 20 can complete the opening inspection process even if the key switch 32 is not in the on position for a long time, which can suppress increase in fuel consumption of the engine.

According to the embodiment, the work machine 1 can complete the opening inspection process at a port or a storage yard of the destination. Therefore, the communication terminal device 20 can collect the operational information on the work machine 1 and transmit the same to the management device 40 while the work machine 1 is transported from the port or the storage yard of the destination to the next destination of the work machine 1, for example, an agency. Accordingly, it is possible to comprehend the status of the work machine 1 from the arrival at the destination (transport destination) to the next transport destination.

In the embodiment, the communication terminal device 20 does not necessarily need to perform the process for determining whether the work machine 1 is located in the specific area ARJ at step S204. Accordingly, after transmitting an acknowledgement of receipt to the management device 40 at step S203 as described above, the communication terminal device 20 may move to step S205 to shift to the opening mode.

Since the opening mode is set under a condition that the key switch 32 is turned on, when the communication terminal device 20 is not configured to determine whether the work machine 1 is located in the specific area ARJ, if the key switch 32 in the work machine 1 under sea transportation is turned on during transmission of the request instruction CMD, for example, the communication terminal device 20 enters the opening mode. Accordingly, wasteful communication costs may occur because communications are made between the communication terminal device 20 and the management device 40 before arrival at the destination. In addition, when the communication terminal device 20 is not configured to determine whether the work machine 1 is located in the specific area ARJ, if the work machine 1 is discharged at a place different from the destination for some reason and the key switch 32 is turned on, the communication terminal device 20 enters the opening mode. In this case, if no certification of communication between the communication terminal device 20 and the management device 40 is acquired at the place different from the destination, for example, a problem may arise.

In the embodiment, the communication terminal device 20 is configured to shift to the opening mode when the work machine 1 is located in the specific area ARJ. Accordingly, the opening inspection process can be executed only by the communication terminal device 20 in the work machine 1 located in the specific area ARJ. That is, the communication terminal device 20 does not enter the opening mode outside of the specific area ARJ at the destination, which makes it possible to suppress occurrence of the foregoing problem.

In the embodiment, the storage unit 20M of the communication terminal device 20 in the work machine 1 may store the destination information Iar such that the destination information Iar is not included in the request instruction CMD. For example, on shipment of the work machine 1 from the manufacturing plant, the storage unit 20M of the communication terminal device 20 in the work machine 1 may store the destination information Iar on the transport destination as far as the transport destination of the work machine 1 is already decided. In such a manner as described above, the communication terminal device 20 can use the destination information Iar stored in the storage unit 20M to determine whether the work machine 1 is located in the specific area ARJ (step S204 of FIG. 4) and shift to the opening mode. When the destination information Iar is included in the request instruction CMD, even If the destination (transport destination) is changed after shipment of the work machine 1, the destination information Iar in the request instruction CMD stored in the storage unit 42 of the management device 40 can be rewritten to the new destination information Iar before transmission to the work machine 1. This makes it easy to respond to changes of the destination after the shipment.

As in the foregoing, the embodiment of the present invention is described. However, the embodiment is not limited to the contents described above. In addition, the constituent elements described above may include ones that can be readily conceived by those skilled in the art, and virtually identical ones, that is, equivalent ones. The foregoing constituent elements can be combined as appropriate. The constituent elements can be subjected to at least one of omission, replacement, and modification in various manners, without deviating from the gist of the embodiment.

### REFERENCE SIGNS LIST

1 Work machine
1S Vehicle-mounted system
3 Management facility
5 Communications satellite
6 Base station
7 RTK-GNSS satellite
20 Communication terminal device
20C Processing unit
20M Storage unit
22 Monitor
24 Storage battery
26 Operational information
30 Signal line
32 Key switch
33 Starter motor
34 Communication unit
35 Location detection device
36 Various sensors
40 Management device
41 Processing unit
42 Storage unit
43 Input/output unit
44 Input/output device
100 Management system
101 Communication line
103 Communication device
104 Antenna
ARJ Specific area
CMD Request instruction
COM Command
Iar Destination information

1. A management system for a work machine, comprising:
a work machine that has a communication terminal device with a communication function, a power source supplying power to the communication terminal device, and a switch interposed between the power source and the communication terminal device; and
a management device that is capable of communication with the communication terminal device and transmits to the communication terminal device a request instruction for execution of a process for enabling the communication, wherein
when the communication terminal device receives the request instruction from the management device, the communication terminal device continues to receive power supply from the power source until after a lapse of a predetermined period of time since the switch turns from an on position to an off position.

2. The management system for the work machine according to claim 1, wherein the communication terminal device executes the process for enabling communication with the management device before a lapse of the predetermined period of time.

3. The management system for the work machine according to claim 1, wherein the request instruction contains location information on a region relating to transport destination of the work machine.

4. The management system for the work machine according to claim 1, wherein, after the communication terminal device executes the process for enabling communication with the management device, when the communication with the management device becomes enabled, the communication terminal device stops operations other than the communication with the management device.

5. The management system for the work machine according to claim 1, wherein, after the communication terminal device executes the process for enabling communication with the management device, when the communication with the management device becomes enabled, the communication terminal device stops operations, and while the switch is in the off position, the communication terminal device is activated for a predetermined second period of time each after a lapse of a predetermined first period of time to communicate with the management device.

6. A management system for a work machine, comprising:
a work machine that has a communication terminal device with a communication function, a power source supplying power to the communication terminal device, a switch interposed between the power source and the communication terminal device, and a location detection device acquiring location information; and
a management device that is capable of communication with the communication terminal device and transmits to the communication terminal device a request instruction containing location information on a region relating to transport destination of the work machine, the request instruction being for execution of a process for enabling the communication, wherein
when the communication terminal device receives the request instruction from the management device, the communication terminal device acquires current location information on the work machine from the location detection device,
when the communication terminal device determines that the work machine is located in a predetermined area of the transport destination from the current location information and the location information contained in the request instruction, the communication terminal device continues to receive power supply from the power source until after a lapse of a predetermined period of time since the switch turns from an on position to an off position, and executes the process for enabling communication with the management device before a lapse of the predetermined period of time.

7. A management method for a work machine by which to manage the work machine that has a communication terminal device with a communication function, a power source supplying power to the communication terminal device, and a switch interposed between the power source and the communication terminal device, by a use of a management system for the work machine including the work machine and a management device that is capable of communication with the communication terminal device and transmits to the communication terminal device a request instruction for execution of a process for enabling the communication, the management method comprising:
receiving the request instruction from the management device; and
when the request instruction is received, continuing to receive power supply from the power source before a lapse of a predetermined period of time since the switch turns from an on position to an off position.

8. A work machine, comprising:
a communication terminal device with a communication function;
a power source supplying power to the communication terminal device; and
a switch interposed between the power source and the communication terminal device, wherein
when the communication terminal device receives a request instruction for execution of a process for enabling communication with the management device, the communication terminal device continues to receive power supply from the power source until after a lapse of a predetermined period of time since the switch turns from an on position to an off position.

9. The work machine according to claim 8, wherein the communication terminal device executes the process for enabling communication with the management device before a lapse of the predetermined period of time.

10. The work machine according to claim 8, wherein the request instruction contains location information on a region relating to transport destination of the work machine.

11. The work machine according to claim 8, wherein, after the communication terminal device executes the process for enabling communication with the management device, when the communication with the management device becomes enabled, the communication terminal device stops operations other than the communication with the management device.

12. The work machine according to claim 8, wherein, after the communication terminal device executes the process for enabling communication with the management device, when the communication with the management device becomes enabled, the communication terminal device stops operations, and while the switch is in the off position, the communication terminal device is activated for a predetermined second period of time each after a lapse of a predetermined first period of time to communicate with the management device.

13. A work machine, comprising:
a communication terminal device with a communication function;
a power source supplying power to the communication terminal device;
a switch interposed between the power source and the communication terminal device; and
a location detection device acquiring location information, wherein
when the communication terminal device receives a request instruction containing location information on transport destination of the work machine, the request instruction being for execution of a process for enabling communication with the management device from the management device, the communication terminal device acquires current location information on the work machine from the location detection device, and
when the communication terminal device determines that the work machine is located in a predetermined area of the transport destination from the current location information and the location information contained in the request instruction, the communication terminal device continues to receive power supply from the power source until after a lapse of a predetermined period of time since the switch turns from an on position to an off position, and executes the process for enabling communication with the management device before a lapse of the predetermined period of time.
